(19) United States
(12) Patent Application Publication
(10) Pub. No.: US 2025/0128735 A1
(43) Pub. Date: Apr. 24, 2025

(54) METHOD FOR MANEUVERING AN AT LEAST PARTIALLY AUTONOMOUS VEHICLE AT A JUNCTION

(71) Applicant: Volvo Car Corporation, Göteborg (SE)

(72) Inventors: Derong YANG, Göteborg (SE); Zhennan FEI, Göteborg (SE)

(73) Assignee: Volvo Car Corporation, Göteborg (SE)

(21) Appl. No.: 18/918,396

(22) Filed: Oct. 17, 2024

(30) Foreign Application Priority Data
Oct. 18, 2023 (EP) 23204395.0

(51) Int. Cl. B60W 60/00; B60W 30/18; G06V 10/141

(52) U.S. Cl. CPC B60W 60/0015; B60W 30/18159; G06V 10/141; B60W 2420/403; B60W 2420/408; B60W 2420/54; B60W 2554/4041; B60W 2554/4042; B60W 2554/4044

(57) ABSTRACT

The disclosure relates to a method for maneuvering an at least partially autonomous vehicle from a first road positioned at a junction into a second road meeting the first road at the junction, the method comprising: observing a first area of the second road for detection of road users by a detection system of the vehicle; altering a detection area of the detection system to include a second area of the second road, the second area comprising a further area of the second road that is not comprised in the first area; observing the second area of the second road for detection of the road users by the detection system; and maneuvering the vehicle into the second road based on the observing of the second area of the second road.

### CROSS-REFERENCE TO RELATED APPLICATIONS

This application claims the benefit of European Patent Application Number 23204395.0, filed on Oct. 18, 2023, which is hereby incorporated by reference in its entirety.

### TECHNICAL FIELD

The present disclosure relates to a method for maneuvering an at least partially autonomous vehicle from a first road positioned at a junction into a second road meeting the first road at the junction.

The disclosure is further directed to a vehicle, and a computer program product for maneuvering an at least partially autonomous vehicle from a first road positioned at a junction into a second road meeting the first road at the junction.

### BACKGROUND

Merging of vehicles at junctions, in particular at unsignalized junctions with obstructed view, is a challenge for drivers and autonomous vehicles. Vehicles on the main road of the junction struggle to detect vehicles merging into the main road in time, while for those vehicles which are attempting to merge into the main road, assessing traffic conditions on the main road proves to be difficult.

### SUMMARY

The above problem is at least partially solved or alleviated by the subject matter of the independent claims of the present disclosure, wherein further examples are incorporated in the dependent claims.

According to a first aspect, there is provided a method for maneuvering an at least partially autonomous vehicle from a first road positioned at a junction into a second road meeting the first road at the junction, the method comprising:
observing a first area of the second road for detection of road users by a detection system of the vehicle,
altering a detection area of the detection system to include a second area of the second road, the second area comprising a further area of the second road that is not comprised in the first area,
observing the second area of the second road for detection of road users by the detection system, and
maneuvering the vehicle into the second road based on the observing of the second area of the second road.

A method for maneuvering an at least partially autonomous vehicle from a first road positioned at a junction into a second road meeting the first road at the junction, the method comprising: observing a first area of the second road for detection of road users by a detection system of the vehicle; altering a detection area of the detection system to include a second area of the second road, the second area comprising a further area of the second road that is not comprised in the first area; observing the second area of the second road for detection of the road users by the detection system; and maneuvering the vehicle into the second road based on the observing of the second area of the second road.

A system for maneuvering an at least partially autonomous vehicle from a first road positioned at a junction into a second road meeting the first road at the junction, the system comprising: a processor and a non-transitory storage medium comprising instructions that, when executed, causes the processor to: observe a first area of the second road for detection of road users by a detection system of the vehicle; alter a detection area of the detection system to include a second area of the second road, the second area comprising a further area of the second road that is not comprised in the first area; observe the second area of the second road for detection of the road users by the detection system; and maneuver the vehicle into the second road based on the observing of the second area of the second road.

A non-transitory computer-readable medium having stored thereon instructions for maneuvering an at least partially autonomous vehicle from a first road positioned at a junction into a second road meeting the first road at the junction, executable by a computer system to perform operations comprising: observing a first area of a second road for detection of road users by a detection system of the vehicle; altering a detection area of the detection system to include a second area of the second road, the second area comprising a further area of the second road that is not comprised in the first area; observing the second area of the second road for detection of the road users by the detection system; and maneuvering the vehicle into the second road based on the observing of the second area of the second road.

The method of the first aspect is based on the finding that one of the main reasons for the above problem lies in a limited field of view of in-vehicle equipped sensors such as but not limited to, for example, camera, Radio Detection And Ranging (radar) and/or Light Detection and Ranging (lidar), in combination with the trajectories planned and followed by the merging vehicle when merging into the second road, which may be a main road. To increase this critical field of view, the method of the first aspect provides for an altering of the detection area of the second road or main road such that a second area is observed on the second road for detection of road users thereon, which includes a further area that was not visible when the first area of the second road was observed. Accordingly, when taking the observation of the first area and the second area together, the overall field of view can be increased, thus enabling the at least partially autonomous vehicle to perform the maneuvering of the vehicle based on more information about the traffic on the main road and thereby in a safer manner.

The junction may be an unsignalized junction. This means that there are no traffic lights at the unsignalized junction to guide the traffic. The junction may be a T-junction. This means that the first road ends at the second road. The junction may provide only an obstructed view for the vehicle when positioned at the junction and aiming to maneuver into the second road. Objects such as walls, trees, houses and similar may be obstructing the view in such a case, for example. Any one or any combination of the afore-mentioned types of junctions may be present. The vehicle may be configured to detect, in particular by its detection system, the type of junction and alter the detection area based on the detected type of junction.

The altering of the detection area by, e.g., rotating the vehicle, will be described exemplary further below in more detail. In general, the detection area of the detection system may be limited and not include the entirety of the second road, e.g., because of difficult conditions such as nighttime, when the junction has obstructed view or when the vehicle has a detection system which may not overlook the entire second road at once. The second area may fully comprise the first area. Accordingly, the second area may be an increased detection area compared to the first area. However, this must not be necessarily the case. Instead, the second area may be a shifted detection area, which may not or only partially comprise the first area. In this case, a part of the first area may still be observed but the area of detection has been shifted to the further area.

Any of the observing steps may be carried out for a moment or a period of time, e.g., a few seconds, for example. Accordingly, the detection system may momentarily or for a period of time observe the first area and/or the second area such that it may detect road users on the second road at that moment or within that period of time. The detection of road users based on the observing of the second area may include determining their position on the second road, absolute or relative to the vehicle, their direction of travel, their speed and/or their acceleration, for example.

The vehicle is at least partially autonomous. This means that the vehicle may be capable of partial or fully autonomous driving. Partial autonomous driving relates to one or more driving assistance functions such as, but not limited to, cruise control, lane keeping assistant, and distance control assistant, for example. The maneuvering of the vehicle may be carried out at least partially or fully autonomously. In other words, the maneuvering of the vehicle into the second road based on the observing of the second area of the second road may be performed at least autonomously by the vehicle. The maneuvering of the vehicle does not need to be based on the observing of the second area of the second road only but may further be based on the observing of the first area, a third area as described further below and/or further information, which may be from a V2X communication with one or more entities, e.g., the road users on the second road, for example.

In an example, the observing of the second area of the second road may comprise detecting at least one road user in the further area of the second road by the detection system. Accordingly, the detection area may be increased or shifted by including the further area such that at least one road user is detected therein. Without the increased or shifted detection area, such at least one road user may not be detectable and lead to a potentially dangerous maneuvering of the vehicle into the second road when the trajectory of the vehicle maneuvering crosses the trajectory of the at least one road user in the further area.

In an example, the method may comprise detecting the at least one road user in the further area of the second road prior to altering the detection area, the detection of the at least one road user being based on an audio recording, by an audio recording system of the vehicle, of sound from the at least one road user in the further area of the second road. Accordingly, the at least one road user in the further area may first be coarsely localized based on its sound, e.g., road sounds or engine sounds. For detecting the position or location of the road user, the recorded audio may be processed to determine the coarse location from which the sound originates. Also, if the audio recording contains different sounds and/or sounds from different locations, the different sounds may be discriminated from one another by such audio processing. Then, for the detection system to detect the at least one road user localized based on its sound, the detection area is altered such that it includes the further area in which it was localized based on its sound. Accordingly, based on the sound detection, the vehicle may know which area of the second road it needs to observe given a potentially limited detection area.

In an example, the method may comprise:
altering the detection area of the detection system to include a third area of the second road, the third area comprising another area of the second road that is not comprised in the first area and second area, and
observing the third area of the second road for detection of road users by the detection system,
   the maneuvering of the vehicle into the second road being further based on the observing of the third area of the second road. Accordingly, there may be more than one step of altering the detection area. For example, the altering of the detection area may mimic the human behavior of looking left and right at junctions due to the eyes limited field of view. Thereby, different areas of the second road may be observed and road users in any of these users may be detected and their thereby determined position, direction of travel and/or speed may be considered when maneuvering the vehicle.

In an example, the method may comprise rotating the vehicle at the junction for altering the detection area. The rotation of the vehicle may be provided by turning the wheels and/or driving forward or backward. The rotation of the entire vehicle for altering the detection area is merely one example. Other examples as described herein may be provided in addition or alternatively to the rotation of the entire vehicle.

In an example, the method may comprise rotating at least one detection unit of the detection system for altering the detection area. Accordingly, the detection system itself with its one or more detection units, may be rotated so as to increase or shift the detection area. For the rotation of the at least one detection unit, the detection system may comprise one or more actuators for rotating the one or more detection units separately or together.

In an example, the at least one rotated detection unit is at least one from a camera detection unit, a LiDAR detection unit, and a radar detection unit. This includes that the detection unit is any one of the afore-mentioned or any combination of two or more of the afore-mentioned detection units.

In an example, the altering of the detection area may comprise increasing at least one of an illumination intensity, an illumination direction, and an illumination area of a vehicle lighting system of the vehicle. The vehicle lighting of the vehicle light system may in particular be an exterior vehicle lighting and include but not be limited to headlights and/or high beams of the vehicle, for example. By increasing the illumination intensity at the junction, the detection area may be increased so that the further area may be included. Also, or alternatively, the direction of illumination may be shifted to shift the detection area, e.g., by rotating the entire vehicle or one or more vehicle lighting units, e.g., the headlights, of the vehicle. Additionally, or alternatively, the illumination area of the detection area may generally be increased or decreased, e.g., by switching modes of the vehicle lighting. For example, it may be switched between a mode in which the headlights are activated and a mode in which the high beams are activated additionally or instead.

In an example, at least one of the illumination intensity and the illumination area of the vehicle lighting system may be increased by operating a high beam lighting system of the vehicle lighting system of the vehicle. While it may not generally be feasible to always operate the high beam lighting system at night due to the potential of distracting other road users, it may be used for a short period of time to alter the detection area and thereby detect road users in the further area, ultimately increasing the traffic safety by preventing collisions at junction.

In an example, the illumination intensity of the vehicle lighting system may be increased based on an ambient light measurement of an ambient light sensor system of the vehicle. Accordingly, the illumination intensity, e.g., of the high beam lighting system, may be selected such that it is increased only as much as needed to detect the second area and without significantly distracting the road users in the second area.

In an example, the method may comprise initiating a signaling or increasing an amount of signaling of the vehicle to road users on the second road before and/or upon maneuvering the vehicle into the second road relative to a nominal signaling value. The nominal signaling value may be a normal value indicative of an amount of signaling during normal operation of the vehicle at the junction, i.e., without having the amount of signaling increased. The signaling may relate to a sound, light and/or any other signal emitted from the vehicle, for example.

In an example, the amount of signaling may be a volume of a sound, the sound being emitted from the vehicle. This provides for a simple yet efficient way of making road users on the second road aware of the vehicle positioned at the junction and aiming to maneuver into the second road, thereby increasing traffic safety.

In an example, the emitted sound may be an engine sound, the sound being emitted from an engine sound simulation unit for simulating an engine sound of the vehicle. For example, the vehicle may be an electric vehicle. Accordingly, even though the road sounds emitted from the vehicle, in particular electric vehicle, are less compared to internal combustion engine vehicles, the engine sound simulation unit may be activated to initiate the signaling or increase the amount of signaling such that road users on the second road may still be made aware of the vehicle positioned at the junction and aiming to maneuver into the second road.

According to a second aspect, there is provided a vehicle comprising means configured to execute the method of the first aspect of this disclosure. Such means may include the detection system for observing the first area and the second area and computer means, e.g., a microprocessor or computer. Such computer means or further computer means may also be configured to maneuver the vehicle at least partially autonomously into the second road. Further, the vehicle may comprise means for altering the detection area, which may be the computer means as mentioned above and which may be configured to rotate the vehicle in its entirety, or, alternatively or additionally, means, such as an actuator, to rotate the at least one detection unit of the detection system, the high beam lighting system and/or the engine sound simulation unit, for example.

According to a third aspect, there is provided a computer program product comprising instructions to cause a vehicle to execute the method of the first aspect of this disclosure. The computer program product may be a computer program as such or a product, e.g., a computer-readable storage medium, having stored thereon the instructions.

It should be noted that the above examples may be combined with each other irrespective of the aspect involved. Accordingly, the method may be combined with structural features and, likewise, the apparatus and the system may be combined with features described above with regard to the method.

These and other aspects of the present disclosure will become apparent from and elucidated with reference to the examples described hereinafter.

### BRIEF DESCRIPTION OF DRAWINGS

Examples of the disclosure will be described in the following with reference to the following drawings.

FIG. 1 shows steps of a method according to an example of this disclosure;

FIG. 2 shows a vehicle according to an example of this disclosure; and

FIGS. 3-5 show a junction with the vehicle of FIG. 2, in which the vehicle carries out different steps of the method of FIG. 1.

### DETAILED DESCRIPTION

The Figs. are merely schematic representations and serve only to illustrate examples of the disclosure. Identical or equivalent elements are in principle provided with the same reference signs.

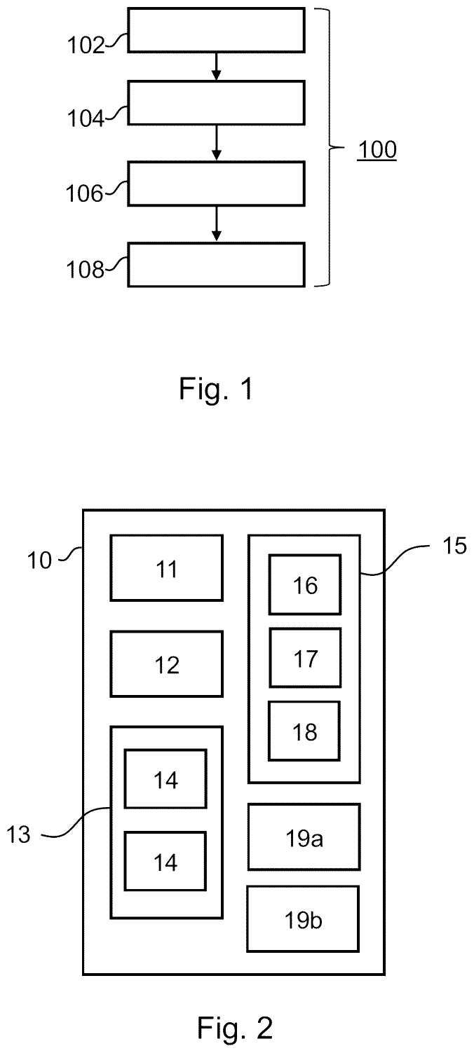

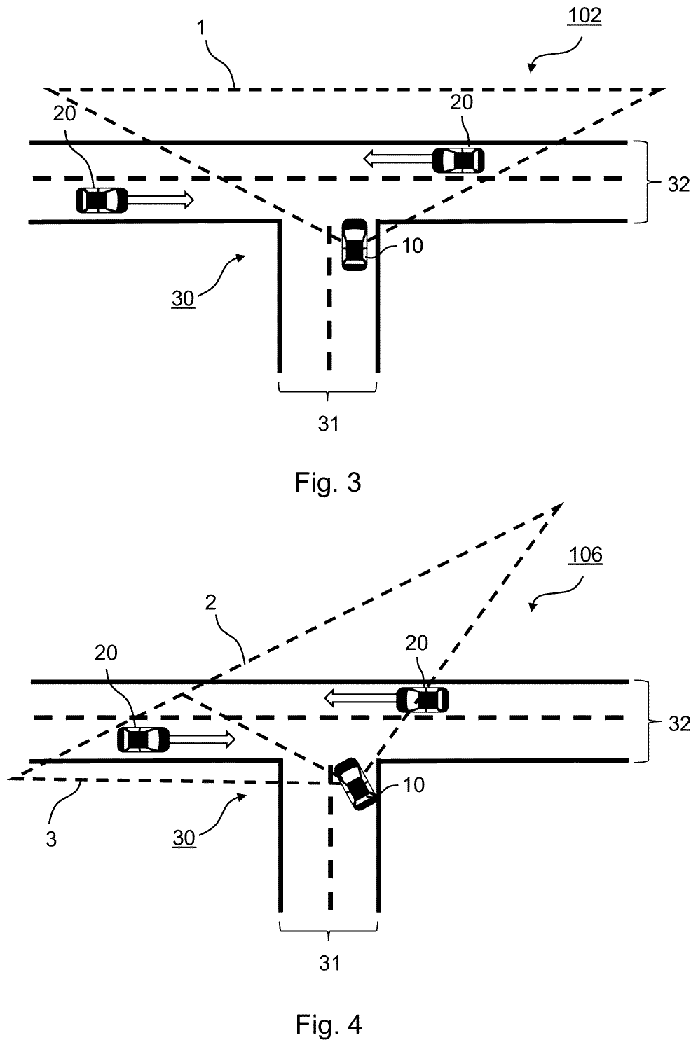

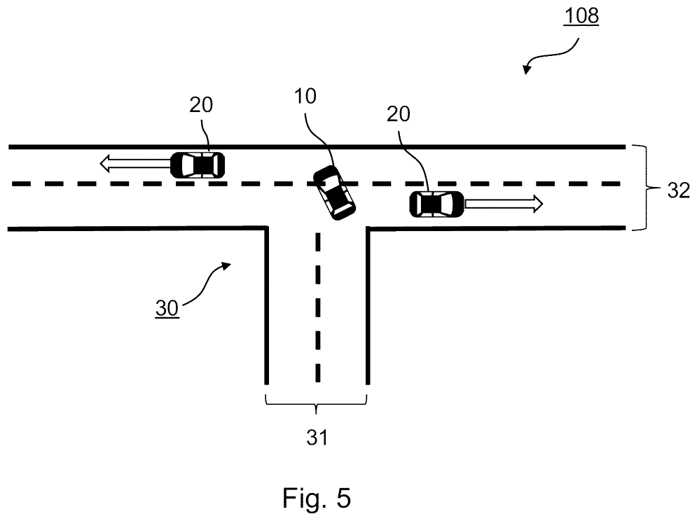

FIG. 1 shows a method 100 for maneuvering an at least partially autonomous vehicle 10 (see FIGS. 2 to 5) from a first road 31 positioned at a junction 30 into a second road 32 meeting the first road 31 at the junction 30 (see FIGS. 3 to 5). The junction 30 in FIGS. 3 to 5 is exemplary shown as an unsignalized T-junction.

FIG. 2 shows the vehicle 10 in a schematic manner with its components. The vehicle 10 may be at least partially autonomous and/or an electric vehicle. The vehicle 10 comprises a computer 11 and a computer program product 12. The computer program product 12 comprises instructions executable by the computer 11 such that the method 100 is being carried out.

The vehicle 10 further comprises a detection system 13 which may comprise one or more detection units 14, such as a camera detection unit, a LiDAR detection unit, and a radar detection unit, for example. Further, the vehicle 10 may comprise a vehicle lighting system 15, which may comprise a headlight lighting system 16, a high beam lighting system 17, and an ambient light sensor system 18. Moreover, the vehicle 10 may comprise an engine sound simulation unit 19a and/or an audio recording system 19b.

In step 102 of method 100, as illustrated exemplary in FIG. 3, the detection system 13 observes a first area 1 of the second road 32 such that it may detect road users 20 thereon. The first area 1 may be defined in size by a detection area of the detection system 13 in terms of its capabilities. In the example of FIG. 3, the detection system 13 may detect the road user 20 in form of a further vehicle to the right of the vehicle 10. For example, the detection system 13 by means of its at least one detection unit 14 may be capable of detecting the position, speed, travel direction, etc. of the road user 20. However, in this exemplary case, the vehicle 10 is not able to see the road user 20 in form of a further vehicle to the left of the vehicle 10 because the left road user 20 is outside of the first area 1. This may lead to a potentially dangerous situation when the at least partially autonomously maneuvered vehicle 10 is to make a left or right turn at the junction 30 based on the observation of the detection system 13.

To avoid such potentially dangerous situations, method 100 comprises a step 104, in which the detection area of the detection system 13 is altered to include a second area 2 of the second road 32 as exemplary shown in FIG. 4. The second area 2 comprises a further area 3 of the second road 32 that is not comprised in the first area 31. Thereby, in step 106 of method 100, the detection system 13 may observe the second area 2 of the second road 32 for detection of road users 20. As may be taken from the example of FIG. 4, the vehicle 10 is now able to detect the left road user 20 in the further area 3 such that the at least partially autonomous vehicle 10 is aware of the left road user 20 and takes it into consideration when maneuvering the vehicle 10 into the second road 30, which corresponds to step 108 of method 100 as exemplary illustrated in FIG. 5.

Before observing the further area 3 by the detection system 13, the method 100 may further include detecting the left road user 20 in the further area 3 of the second road 32 based on an audio recording by the audio recording system 19b, the audio recording including the sound from the left road user 20. For the detection of the road user 20 to the left in the example of FIGS. 3 and 4, the recorded audio may be audio processed to detect the direction of the recorded sounds such that it may be estimated where the sound originates from, i.e., where a road user 20 emitting the sound is coarsely located on the second road 32. Accordingly, a visual-based detection area of the detection system 13 may be altered based on a prior audio-based detection of one or more road users 20 rather than altering the detection area at random.

The altering of the detection area of the detection system 13 is shown in FIG. 4 exemplary as a rotation of the entire vehicle 10. However, alternatively, or additionally, the detection area may be altered by rotating at least one of the detection units 14, by increasing at least one of an illumination intensity, an illumination direction, and an illumination area of a vehicle lighting system 15 of the vehicle 10, e.g., by operating a high beam lighting system 17 thereof in addition or alternatively to the headlight lighting system 16, and/or by initiating a signaling of the vehicle 10 to road users 20 on the second road 32, e.g., by operating the engine sound simulation unit 19a. The variant of the lighting altering may be based on an ambient light measurement of the ambient light sensor system 18. An advantage of the increased illumination and/or sound is that the road users 20 on the second road 32 may be made aware of the vehicle 10 and thereby increase safety.

Further, steps 104 and 106 may be repeated such that other areas are included, which are not visible in the first area 1 or second area 2. Moreover, further steps of the method 100 may be employed which relate to the positioning of the vehicle 10 at the junction 30. In particular, the method 100 may comprise nudging of the vehicle 10 into the second road 32 before maneuvering the vehicle 10 into the second road 32. This may further increase the detection area of the detection system 13. If the vehicle 10 is nudged into the second road 32, the vehicle 10 may also pull back, if needed, e.g., if a road user 20 is coming close to the vehicle 10 and there would otherwise be a risk of an accident. The amount of nudging of the vehicle 10 into the second road 32 may be determined by a machine learning model, which may be utilized by the computer 11, for example. Further, the method 100 may comprise performing a risk assessment for maneuvering the vehicle 10 into the second road 32. The risk assessment may consider any detected road users 20 during observation of the first area, the second area and/or any further area of the second road 32. Accordingly, based on the risk assessment, the maneuvering of the vehicle 10 into the second road 32 may be timed such that it is performed when the risk is the lowest or lower than a threshold.

As used herein, the phrase “at least one,” in reference to a list of one or more entities should be understood to mean at least one entity selected from any one or more of the entities in the list of entities, but not necessarily including at least one of every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one example, to at least one, optionally including more than one, A, with no B present (and optionally including entities other than B); in another example, to at least one, optionally including more than one, B, with no A present (and optionally including entities other than A); in yet another example, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

Other variations to the disclosed examples can be understood and effected by those skilled in the art in practicing the claimed disclosure, from the study of the drawings, the disclosure, and the appended claims. In the claims the word “comprising” does not exclude other elements or steps and the indefinite article “a” or “an” does not exclude a plurality. The mere fact that certain measures are recited in mutually different dependent claims does not indicate that a combination of these measures cannot be used to advantage. A computer program product may be stored/distributed on a suitable medium such as an optical storage medium or a solid-state medium supplied together with or as part of other hardware, but may also be distributed in other forms, such as via the Internet or other wired or wireless telecommunication systems. Any reference signs in the claims should not be construed as limiting the scope of the claims.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the term “or” means an inclusive “or” rather than an exclusive “or.” That is, unless specified otherwise, or clear from context, “X uses A or B” means any of the natural inclusive permutations. That is, if X uses A; X uses B; or X uses both A and B, then “X uses A or B” is satisfied under any of the foregoing instances.

As used herein the term “component” refers to a distinct and identifiable part, element, subsystem, or unit within a larger system, structure, or entity. It is a building block that serves a specific function or purpose within a more complex whole. Components are often designed to be modular and interchangeable, allowing them to be combined or replaced in various configurations to create or modify systems. Components may be a combination of mechanical, electrical, hardware, firmware, software, and/or other engineering elements.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

A computing device or system may include a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The computing system may include clients and servers. A client and server are remote from each other and typically interact through a communication network. The relationship of the client and server arises by virtue of computer programs running on the respective computers and having a client-server relationship with each other.

The terms “non-transitory computer-readable storage medium” and “machine-readable storage medium” include a single medium or multiple media such as a centralized or distributed database, and/or associated caches and servers that store one or more sets of instructions. Further, the terms “non-transitory machine-readable storage medium” and “machine-readable storage medium” include any tangible medium that is capable of storing, encoding, or carrying a set of instructions for execution by a processor that, for example, when executed, cause a system to perform any one or more of the methods or operations disclosed herein. As used herein, the term “machine-readable storage medium” is expressly defined to include any type of computer-readable storage device and/or storage disk and to exclude propagating signals.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

Further, a computer system including one or more processors and machine-readable storage media such as computer memory may practice the methods. In particular, one or more processors execute computer-executable instructions, stored in the computer memory, to perform various functions such as the acts recited in the embodiments.

As used herein the term “data processing unit” may be used interchangeably with processor in many contexts. Both terms generally refer to a component or unit within a computing system that is responsible for carrying out operations on data. The processor, or central processing unit (CPU), is an element of a computer that performs arithmetic and logic operations, executes instructions from computer programs, and manages data movement within the system.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Machine-readable storage media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a machine-readable storage medium for execution by, or to control the operation of, data processing apparatus. The machine-readable storage medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by machine-readable storage program instructions. These computer-readable program instructions can be provided to a processor of a general purpose computer, special purpose computer and/or other programmable data processing apparatus to produce a machine, such that the instructions, which execute via the processor of the computer or other programmable data processing apparatus, for implementing the functions/acts specified in the flowchart and/or block diagram block or blocks. These computer-readable program instructions can also be stored in a computer-readable storage medium that can direct a computer, a programmable data processing apparatus and/or other devices to function in a particular manner, such that the computer-readable storage medium having instructions stored therein can comprise an article of manufacture including instructions which can implement aspects of the function/act specified in the flowchart and/or block diagram block or blocks. The computer-readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

### LIST OF REFERENCE SIGNS

1 first area
2 second area
3 further area
10 vehicle
11 computer
12 computer program product
13 detection system
14 detection unit
15 vehicle lighting system
16 headlight lighting system
17 high beam lighting system
18 ambient light sensor system
19a engine sound simulation unit
19b audio recording system
20 road user
30 junction
31 first road
32 second road
100 method
102-108 steps

What is claimed is:

1. A method for maneuvering an at least partially autonomous vehicle from a first road positioned at a junction into a second road meeting the first road at the junction, the method comprising:
observing a first area of the second road for detection of road users by a detection system of the vehicle;
altering a detection area of the detection system to include a second area of the second road, the second area comprising a further area of the second road that is not comprised in the first area;
observing the second area of the second road for detection of the road users by the detection system; and
maneuvering the vehicle into the second road based on the observing of the second area of the second road.

2. The method of claim 1, wherein the observing of the second area of the second road comprises detecting at least one road user in the further area of the second road by the detection system.

3. The method of claim 2, further comprising: detecting the at least one road user in the further area of the second road prior to altering the detection area, wherein the detection of the at least one road user is based on an audio recording, by an audio recording system of the vehicle, wherein the audio recording is of sound from the at least one road user in the further area of the second road.

4. The method of claim 1, further comprising:
altering the detection area of the detection system to include a third area of the second road, wherein the third area comprises another area of the second road that is not comprised in the first area and the second area; and
observing the third area of the second road for detection of the road users by the detection system; and
wherein the maneuvering of the vehicle into the second road is further based on the observing of the third area of the second road.

5. The method of claim 1, further comprising rotating the vehicle at the junction for altering the detection area.

6. The method of claim 1, further comprising rotating at least one detection unit of the detection system for altering the detection area.

7. The method of claim 6, wherein the at least one rotated detection unit is at least one of a camera detection unit, a LiDAR detection unit, and a radar detection unit.

8. The method of claim 1, wherein the altering of the detection area comprises increasing at least one of an illumination intensity, an illumination direction, and an illumination area of a vehicle lighting system of the vehicle.

9. The method of claim 8, wherein at least one of the illumination intensity and the illumination area of the vehicle lighting system is increased by operating a high beam lighting system of the vehicle lighting system of the vehicle.

10. The method of claim 8, wherein the illumination intensity of the vehicle lighting system is increased based on an ambient light measurement of an ambient light sensor system of the vehicle.

11. The method of claim 1, further comprising one of initiating a signaling and increasing an amount of signaling of the vehicle to the road users on the second road before maneuvering the vehicle into the second road relative to a nominal signaling value.

12. The method of claim 11, wherein the amount of signaling is a volume of a sound, and wherein the sound is emitted from the vehicle.

13. The method of claim 12, wherein the emitted sound is an engine sound, and wherein the sound is emitted from an engine sound simulation unit for simulating an engine sound of the vehicle.

14. The method of claim 1, wherein the first area is within a field of view of the detection system; and wherein the second area is within a shifted field of view of the detection system.

15. The method of claim 2, further comprising: detecting, by the detection system, a type of the junction, and altering the detection area based on the type of the junction.

16. The method of claim 2, wherein the detecting of the at least one road user comprises one of determining a position of the road user relative to the vehicle, determining a direction of travel of the road user, and determining a speed of travel of the road user.

17. A system for maneuvering an at least partially autonomous vehicle from a first road positioned at a junction into a second road meeting the first road at the junction, the system comprising:
a processor and a non-transitory storage medium comprising instructions that, when executed, causes the processor to:
observe a first area of the second road for detection of road users by a detection system of the vehicle;
alter a detection area of the detection system to include a second area of the second road, the second area comprising a further area of the second road that is not comprised in the first area;
observe the second area of the second road for detection of the road users by the detection system; and
maneuver the vehicle into the second road based on the observing of the second area of the second road.

18. The system of claim 17, wherein the system is a component of a vehicle.

19. The system of claim 17, is further configured to:
alter the detection area of the detection system to include a third area of the second road, wherein the third area comprises another area of the second road that is not comprised in the first area and the second area; and
observe the third area of the second road for detection of the road users by the detection system; and
wherein the maneuvering of the vehicle into the second road is further based on the observing of the third area of the second road.

20. A non-transitory computer-readable medium having stored thereon instructions for maneuvering an at least partially autonomous vehicle from a first road positioned at a junction into a second road meeting the first road at the junction, executable by a computer system to perform operations comprising:
observing a first area of a second road for detection of road users by a detection system of the vehicle;
altering a detection area of the detection system to include a second area of the second road, the second area comprising a further area of the second road that is not comprised in the first area;
observing the second area of the second road for detection of the road users by the detection system; and
maneuvering the vehicle into the second road based on the observing of the second area of the second road.
